(19) United States
(12) Patent Application Publication
(10) Pub. No.: US 2005/0232673 A1
(43) Pub. Date: Oct. 20, 2005

(54) Device for printing one or serveral objects moving in a feed direction

(76) Inventor: Manfred Korthauer, Mulheim/Ruhr (DE)

Correspondence Address: WILLIAM COLLARD;COLLARD & ROE, P.C., 1077 NORTHERN BOULEVARD, ROSLYN, NY, 11576, US

(21) Appl. No.: 10/522,352

(22) PCT Filed: Aug. 30, 2003
(86) PCT No.: PCT/EP03/09641

§ 371 Date: Jan. 26, 2005

(30) Foreign Application Priority Data
Sep. 11, 2002 (DE) 10242477.2

(51) Int. Cl. B41J 2/32

(52) U.S. Cl. 400/120.16; 400/120.01

(57) ABSTRACT

The invention relates to a device for printing one or several objects moving in a feed direction, in particular labels, packaging and packaging sections on a flat strip (1) or labels (2) stuck on a support band strip, comprising a print head (4) and means for introducing the object for printing to the print head. According to the invention, the supply speed of the material for printing and thus the printing capacity or labelling capacity of the device may be increased, without reducing the print quality and without increasing the wear on the print head (4) caused by the abrasive effect of the object, whereby the print head is provided with a drive (9, 11-16), by means of which the print head (4) may be moved in the feed direction of the object for printing and counter to the feed direction of the object.

The invention relates to a device for printing one or several objects moving in a feed direction, especially labels, packaging, packaging sections, a band strip or labels stuck on a support band strip, comprising a print head and means for supplying the object to be printed to the print head.

Such a device is known, for example, from DE 195 07 892 A1. In the known device a label tape, which consists of a carrier tape strip with labels adhering detachably thereto, is guided between a thermal print head and a pressure roller and printed using thermal printing or thermal transfer methods. The labels are then separated from the carrier tape using a separating device by guiding said carrier tape around a dispensing edge. The print head is fixed in a stationary position in the device and during printing using the thermal method, stays on the label or the carrier tape strip during the entire transport and printing time.

Furthermore, generic devices are known in which the print head is raised from the label and from the carrier tape strip for the times during which no printing takes place.

The printing speed of a thermal printer is limited with regard to the print quality. Furthermore, the wear of the thermal strip increases with increasing speed.

The object of the present invention is to improve a device of the type specified initially so that it offers a high printing capacity or labelling capacity without diminution of the print quality and/or increased wear of the thermal strip.

This object is solved by a device having the features of claim 1. The device according to the invention is substantially characterised by the fact that the print head is provided with a drive by means of which the print head can be moved in the feed direction of the object for printing and counter to the feed direction of the object.

In the device according to the invention the supply speed of the object to be printed can thus be increased without increasing the maximum print speed of the print head which is selected depending on the desired print quality and the lifetime of the thermal strip. The device according to the invention thus makes it possible to increase the supply speed of the object for printing and thus the printing capacity or labelling capacity without lowering the print quality and without increasing the wear of the thermal strip.

According to a preferred embodiment of the device according to the invention, the print head can be provided with a device by means of which the print head can be moved onto the object to be printed and moved away from the object. This arrangement makes it possible to raise the print head from the object during pauses in printing and motion counter to the feed direction of the object. Abrasion-induced wear of the print head is hereby minimised.

According to a further preferred embodiment of the invention, the drive by means of which the print head can be moved in the feed direction of the object to be printed and counter to the feed direction of the object, can be allocated a control system which controls this drive such that during movement in the feed direction of the object to be printed the print head has the same speed as the object to be printed or a lower speed than the object to be printed. In this case, means for recording the supply speed of the object to be printed can preferably be provided, which means transmit measuring signals proportional to the supply speed to the control system, wherein the control system controls the movement of the print head depending on the recorded supply speed.

A further advantageous embodiment of the invention is characterised in that the drive by means of which the print head can be moved in the feed direction and counter to the feed direction of the band strip, has a slider-crank mechanism or a piezo-actuator. With a slider-crank mechanism, particularly fast forward- and backward-directed sliding movements of the print head parallel to the feed direction of the band strip can be achieved in a reliable fashion. The same applies to a piezo-actuator.

An advantageous further development of the device according to the invention consists in the fact that the stroke length of the slider-crank mechanism is adjustable. This arrangement makes it possible to adapt the forward- and backward-directed sliding movements of the print head parallel to the feed direction of the band strip depending on the label length and/or the spacing of the labels to be printed, which are stuck on the band strip.

A preferred embodiment of the device according to the invention further consists in the fact that the print head is attached to a support mounted in a sliding guide which support also carries the drive by means of which the print head can be moved onto the band strip and away from the band strip. This drive can in this case have a cam disk or a circular disk with eccentrically arranged axis of rotation by means of which the print head can be brought in contact with the band strip against the action of at least one spring element, preferably a helical spring.

Instead of a printing roller as it is present in conventional generic devices having a stationarily arranged print head, in the device according to the invention, a preferably plate-shaped counter-bearing can be arranged opposite to the print head, over which the back side of the band strip slides during its feed.

Further preferred and advantageous embodiments of the device according to the invention are specified in the dependent claims.

The invention is explained in detail subsequently with reference to drawings which show several exemplary embodiments. In the figures:

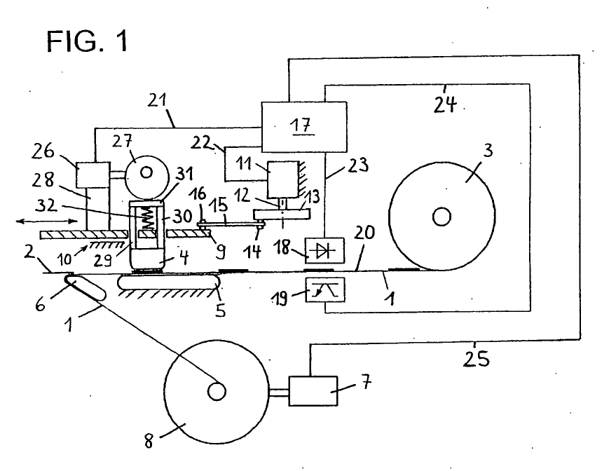

FIG. 1 is a schematic diagram of the device according to the invention according to a first exemplary embodiment, not to scale and

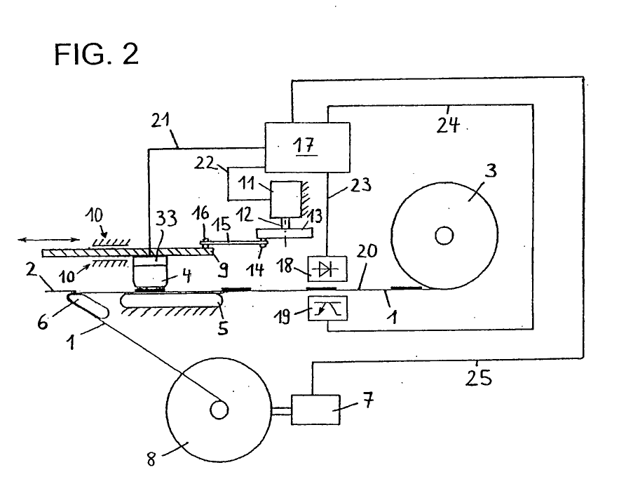

FIG. 2 is a schematic diagram of the device according to the invention according to a second exemplary embodiment, not to scale.

FIG. 1 shows a device for printing labels 2 stuck on a support band strip 1. The labels 2 are attached to the support band strip 1 at substantially the same distance from one another. The band strip 1 is unwound from a supply roll 3 and fed to a printing mechanism. The printing mechanism consists of a print head 4 in the form of a thermal printing head and a plate-shaped counter-bearing 5 having a smooth surface over which the back side of the band strip 1 slides during its feeding. The print head 4 is constructed as strip-shaped and extends transverse to the feed direction of the band strip 1 substantially over its width or the width of the labels. The print head 4 presses the labels 2 with a sufficient force against the fixedly arranged plate-shaped counter-bearing 5 and prints them, for example, using the thermal printing or thermal transfer method. After the printing mechanism in the direction of travel of the strip there is provided a relatively sharp deflection in the form of a dispensing edge 6 at which the printed labels 2 can be detached in a per se known fashion from the support band strip 1 and removed through an opening in the housing of the device and can be applied to an object to be labelled. After the deflection at the dispensing edge 6, the support band strip 1 is wound onto a take-up roller 8 of a winding-on device driven by a stepping motor 7. The rotational speed of the stepping motor 7 or the take-up roller 8 is preferably continuously adjustable.

The thermal printing head 4 is held on a plate-shaped support 9 which is mounted in a sliding guide 10. The schematically represented sliding guide 10 can for example be formed from roller bearings. The support 9 is provided with a drive by means of which it and thus the print head 4 can be moved parallel to the feed direction and counter to the feed direction of the band strip 1. This is indicated by the double arrow. In the exemplary embodiment shown the drive comprises a stationarily arranged motor 11, preferably an electric motor whose motor shaft 12 drives a circular disk 13. The circular disk 13 has an eccentrically arranged pin 14 on which one end of a joint rod 15 is hinged. The other end of the joint rod 15 is hinged with a pin 16 attached to the support 9. The circular disk 13 with the eccentrically arranged pin 14, the joint rod 15 hinged thereon and the support 9 mounted in a sliding guide with the hinge pin 16′ attached thereon thus form a slider-crank mechanism. The distance between the axis of rotation of the motor shaft 12 and the central point of the pivot pin 14 attached to the circular disk 13 determines the stroke length of the slider-crank mechanism.

In order to be able to displace the print head 4 if necessary with different stroke lengths in the feed direction and counter to the feed direction of the support band strip 1, the distance of the pivot pin 14 with reference to the axis of rotation of the motor shaft 12 is adjustable and the pivot pin 14 is accordingly displaceably and fixedly mounted on the circular disk 13.

The motor 11 of the drive has assigned to it a control system 17 which controls the drive such that during movement in the feed direction of the support band strip 1 the print head 4 has the same speed as the support band strip 1 or a lower speed than the support band strip 1. The reference numbers 18 and 19 denote a light-emitting transmitter diode and a receiving diode which reacts to light, which are part of a measuring device to record the supply speed of the support band strip 1. The labels 2 spaced substantially uniformly with respect to one another or other markings spaced substantially uniformly with respect to one another on the support band strip 1 interrupt the reception of the light emitted by the transmitter diode 18 at the receiving diode 19 if the band strip is constructed as transparent. If the receiving diode is to receive the light emitted by the transmitter diode as a result of light reflection on the labels 2 or on the label-free sections 20 of the support band strip 1, said receiving diode should be arranged, in contrast to the representation shown in the drawing, together with the transmitter diode 18 on the side of the support band strip 1 facing the labels 2.

Alternatively to the transmitter and receiving diodes 18, 19, other means can also be used to record the supply speed of the support band strip, e.g. a dynamo unrolling on the support band strip or the like.

The receiving diode 19 or the dynamo delivers measurement signals which are proportional to the supply speed of the support band strip 1. These signals are fed to the measuring and control device 17 which controls the rotational speed of the motor shaft 12 and thus the translatory movement of the support 9 and print head 4 depending on the recorded supply speed of the support band strip 1.

The support 9 is provided with a device by means of which the print head 4 can be moved onto the support band strip 1 and away from the support band strip 1. This device is also connected via a signal line 21 to the measuring and control device 17 and comprises an electric motor 26, preferably a stepping motor, and a circular disk 27 with an eccentrically arranged axis of rotation. A holder for the motor 26 constructed on the support 9 is designated by 28. The support 9 is shown in longitudinal cross-section in the drawing. The print head 4 is provided with rods 29, 30 running parallel to one another, which are guided in sliding bearings formed in the support 9. The upper ends of the rods 29, 30 are connected to one another by means of a transverse bar 31. Arranged between the support and the transverse bar is a spring element 32 in the form of a helical spring which moves the print head 4 away from the band strip. By means of the eccentrically mounted circular disk 27 which acts on the upper side of the transverse bar 31, the print head 4 can be brought in contact with the support band strip 1 or the respective label 2 to be printed against the action of the helical spring 32.

The measuring and control device 17 controls the drives in such a fashion that during movement in the feed direction of the support band strip 1, the print head 4 rests on a label 2 to be printed, which is stuck on the support band strip and during movement counter to the feed direction of the band strip 1, said print head is moved at a distance from the support band strip or the labels 2 adhering thereon.

The exemplary embodiment shown in FIG. 2 differs from the exemplary embodiment according to FIG. 1 merely in that instead of the electric motor 26, the eccentrically mounted circular disk 27, the holder 28, the parallel guide formed from the rods 29, 30 and the transverse bar 31 and the spring element 32, at least one piezo-actuator 33 is used in order to raise and lower the print head 4. In FIG. 2 the thermal print head 4 is affixed to at least one piezo-actuator 33 which for its part is held on the underside of the plate-shaped support 9. The support 9 is in turn mounted in a sliding guide 10. However, instead of the sliding guide 10, as already mentioned a roller bearing can also be used.

The invention is not restricted in its execution to the exemplary embodiments described herein before. Rather, several variants are feasible which also make use of the inventive idea, as disclosed in the claims, with a fundamentally different design. In particular, the invention is not restricted to the printing of labels stuck on a support band strip. Likewise, the invention can also be used to print continuous paper (so-called linerless) provided with an adhesive on one side, individually supplied labels without support paper and package envelopes to be partially printed, made of paper or cardboard.

1-12. (canceled)

13. A device for printing one or several objects moving in a feed direction, especially labels, packaging, packaging sections, a band strip (1) or labels (2) stuck on a support band strip, comprising a thermal print head (4) and means for supplying the object to be printed to the thermal print head, wherein the thermal print head (4) is provided with a drive (9, 11-16) by means of which the print head (4) can be moved in the feed direction of the object to be printed and counter to the feed direction of the object,
characterised in that the drive is constructed such that the thermal print head (4) can be moved parallel to the feed direction of the object to be printed in its feed direction and counter to its feed direction, wherein the drive is assigned to a control system (17) which controls it such that during movement parallel to the feed direction of the object the thermal print head (4) has the same speed as the object being moved or a lower speed than the object being moved and that during movement counter to the feed direction of the object the thermal print head (4) is moved at a distance from the object or labels (2) stuck thereto.

14. The device according to claim 13,
wherein means (18, 19) for recording the supply speed of the object being moved are provided, which means transmit measuring signals proportional to the supply speed to the control system (17) and that the control system (17) controls the movement of the thermal print head (4) depending on the recorded supply speed.

15. The device according to claim 13,
wherein the drive by means of which the thermal print head (4) can be moved in the feed direction and counter to the feed direction of the object to be printed, has a slider-crank mechanism or a piezo-actuator (33).

16. The device according to claim 13,
wherein the stroke length with which the thermal print head (4) can be moved in the feed direction and counter to the feed direction of the object to be printed is adjustable.

17. The device according to claim 13,
wherein the thermal print head is attached to a support (9) mounted in a sliding guide (10), which support carries a further drive by means of which the thermal print head (4) can be moved onto the object to be printed and away from the object.

18. The device according to claim 13,
wherein the thermal print head (4) has assigned to it a cam disk or a circular disk (27) with eccentrically arranged axis of rotation by means of which the thermal print head (4) can be brought in contact with the object to be printed against the action of a spring element (32).

19. The device according to claim 13,
wherein the device by means of which the thermal print head (4) can be moved onto the object to be printed and away from the object has at least one piezo-actuator (33).

20. The device according to claim 13,
wherein opposite to the thermal print head (4) there is arranged a plate-shaped counter-bearing (5) over which the back side of the object to be printed slides during its feed.
